(19) United States
(12) Patent Application Publication
(10) Pub. No.: US 2013/0074944 A1
(43) Pub. Date: Mar. 28, 2013

(54) Methods and Apparatuses for Releasably Fastening Pins

(71) Applicant: IntegenX Inc., Pleasanton, CA (US)

(72) Inventor: Ezra Van Gelder, Palo Alto, CA (US)

(73) Assignee: IntegenX Inc., Pleasanton, CA (US)

(21) Appl. No.: 13/626,765

(22) Filed: Sep. 25, 2012

Related U.S. Application Data
(60) Provisional application No. 61/539,380, filed on Sep. 26, 2011.

(51) Int. Cl. F16L 55/00

(52) U.S. Cl. 137/15.01; 137/315.01

(57) ABSTRACT

The present technology relates to pins that are used for moving liquid samples from source wells into target wells. A releasable fastening mechanism simplifies calibration of positions (e.g., vertical positions) of the pins relative to a frame releasably holding the pins.

### CROSS-REFERENCE

The present application claims the benefit of U.S. Provisional Patent Application No. 61/539,380, filed on Sep. 26, 2011, which is incorporated herein by reference in its entirety.

### BACKGROUND

Pins that dispense samples typically are calibrated such that the ends of the liquid dispensing tips of the pins in an array share the same position on the z-axis, or height. When the pins in the array are lowered into an array of wells, the ends of the liquid dispensing tips of the pins have the same distance from the bottoms of the wells.

The present invention provides an array of pins, wherein the liquid dispensing tip of each pin can have a vertical position independent of the vertical position of the liquid dispensing tip of every other pin in the array (e.g., the liquid dispensing tips of the pins can have the same vertical position or different vertical positions). The pins of the invention are better able to collect liquid from source wells whose bottom surfaces can have different vertical positions and are better able to dispense liquid into target wells whose bottom surfaces can have different vertical positions, including very small volumes of liquid.

### SUMMARY

One aspect of the technology relates to a method comprising the steps of:

moving a frame movably holding at least one hollow bore pin having a liquid dispensing tip, such that the liquid dispensing tip of the at least one hollow bore pin moves into a respective well of a set of target wells, and the liquid dispensing tip makes contact with a bottom surface of the respective well;

continuing to move the frame after the liquid dispensing tip makes contact, such that the at least one hollow bore pin moves to a particular position (e.g., vertical position) within a range of positions (e.g., vertical positions) relative to and permitted by the frame; and

fastening the at least one hollow bore pin to the frame at the particular position of the at least one hollow bore pin relative to the frame.

In one embodiment, the at least one hollow bore pin is a plurality of hollow bore pins, and the method further comprises:

(1) moving the frame toward the set of target wells until each of the plurality of hollow bore pins contacts the bottom surface of a respective well of the set of target wells, wherein each of the plurality of hollow bore pins assumes a position (e.g., vertical position) relative to the frame;

(2) fastening the plurality of hollow bore pins to the frame at the relative positions; and

(3) moving the plurality of hollow bore pins away from the bottom surfaces of the set of target wells.

In another embodiment, the method further comprises:

moving liquid into the plurality of hollow bore pins from a set of source wells; and

moving the frame from the set of source wells to the set of target wells.

In yet another embodiment, the method further comprises:

after fastening, moving the frame from the set of target wells to a set of source wells;

moving liquid into the hollow bore pins from the set of source wells; and

moving the frame from the set of source wells to the set of target wells.

In one embodiment, the at least one hollow bore pin includes a plurality of hollow bore pins, and said continuing to move the frame after the liquid dispensing tip makes contact comprises continuing to move the frame at least until the plurality of hollow bore pins stop moving relative to each other.

In another embodiment, the method further comprises:

moving the liquid dispensing tip of the at least one fastened hollow bore pin to a target distance from the bottom surface of the respective well; and

dispensing a quantity of liquid from the liquid dispensing tip into the respective well.

In still another embodiment, the method further comprises:

moving the liquid dispensing tip of the at least one fastened hollow bore pin to a target distance from the bottom surface of the respective well; and

dispensing a quantity of liquid of no more than about 10, 5, 1 or 0.5 microliter from the liquid dispensing tip into the respective well.

In an additional embodiment, the method further comprises moving the liquid dispensing tip of the at least one fastened hollow bore pin to a target distance from the bottom surface of the respective well, such that a quantity of liquid dispensed from the liquid dispensing tip contacts both the liquid dispensing tip and the bottom surface of the respective well.

In one embodiment, the wells are part of a microfluidic device. In another embodiment, the wells are part of a macrofluidic device.

In one embodiment, the liquid dispensing tips of the plurality of hollow bore pins can have the same vertical position or different vertical positions with respect to each other, or the tip of a pin can have a vertical position independent of the vertical position of the tip of every other pin.

In one embodiment, the bottom surfaces of the set of target wells, and/or the bottom surfaces of the set of source wells, can have the same vertical position or different vertical positions with respect to each other, or the bottom surface of a target well can have a vertical position independent of the vertical position of every other target well, and/or the bottom surface of a source well can have a vertical position independent of the vertical position of every other source well.

In one embodiment, the liquid dispensing tips of the plurality of hollow bore pins are permitted to have misalignment in a vertical position relative to each other such that at least two of the liquid dispensing tips have vertical positions differing by more than about 0.5 mm.

In one embodiment, the wells of the set of target wells are permitted to have misalignment in a vertical position relative to each other such that the bottom surfaces of at least two of the wells have vertical positions differing by more than about 0.5 mm.

Another aspect of the technology relates to an apparatus comprising at least one hollow bore pin, a frame, and a releasable fastening mechanism. The at least one hollow bore pin has a liquid dispensing tip. The frame movably holds the at least one hollow bore pin within a range of positions (e.g., vertical positions) relative to the frame. The releasable fastening mechanism is coupled to the frame and has a first mode in which the at least one hollow bore pin is movable within the range of positions (e.g., vertical positions) relative to the frame and a second mode in which the at least one hollow bore pin is fixed at a particular position (e.g., vertical position) in the range of positions relative to the frame.

In one embodiment, the range of positions lies along a line (e.g., a vertical line).

In one embodiment, the at least one hollow bore pin is a plurality of hollow bore pins, wherein each pin of the plurality of hollow bore pins is fixable at a particular position (e.g., vertical position) relative to the frame independent of the other pins of the plurality of hollow bore pins.

In various embodiments, the releasable fastening mechanism comprises a variable volume bladder, a magnetic fastener or fastening mechanism, or a mechanical fastener or fastening mechanism.

In an additional embodiment, the apparatus further comprises a plurality of tubes, wherein each of the plurality of tubes is in fluidic communication with a respective pin of the plurality of hollow bore pins and is adapted to transmit positive or negative pressure to the respective pin.

Yet another aspect of the technology relates to an apparatus comprising a base, a frame and pin assembly, a releasable fastening mechanism, and a motor. The frame and pin assembly is coupled to the base and comprises a frame movably holding an array of hollow bore pins, wherein each of the hollow bore pins has a liquid dispensing tip and is within a range of positions (e.g., vertical positions) relative to and permitted by the frame. The releasable fastening mechanism is coupled to the frame and has a first mode in which each of the hollow bore pins is movable within the range of positions relative to the frame and a second mode in which each of the hollow bore pins is fixed at a particular position (e.g., vertical position) in the range of positions relative to the frame. The motor is configured to move the frame in X, Y, and Z directions relative to the base.

In one embodiment, the X and Y directions are relative to an X and Y plane defined by the base, and the Z direction is perpendicular to the X and Y plane.

In another embodiment, the apparatus further comprises an array of wells.

In various embodiments, the releasable fastening mechanism comprises a variable volume bladder, a magnetic fastener or fastening mechanism, or a mechanical fastener or fastening mechanism.

In an additional embodiment, the apparatus further comprises a control circuit coupled to the motor and the releasable fastening mechanism, wherein the control circuit is configured:

(i) to cause the motor to move the liquid dispensing tips of the array of hollow bore pins into an array of wells such that the liquid dispensing tips make contact with bottom surfaces of the array of wells, and such that the contact moves the array of hollow bore pins to particular positions within the range of positions (e.g., vertical positions) relative to and permitted by the frame holding the array of hollow bore pins; and

(ii) to cause the releasable fastening mechanism to fasten the array of hollow bore pins to the particular positions relative to the frame and determined by the contact between the liquid dispensing tips and the bottom surfaces of the array of wells.

In one embodiment, the apparatus further comprises a plurality of tubes, wherein each of the plurality of tubes is in fluidic communication with a respective pin of the array of hollow bore pins and is adapted to transmit positive or negative pressure to the respective pin.

### BRIEF DESCRIPTION OF THE DRAWINGS

FIG. 1 is a side view of an exemplary pin.

FIG. 2 is a perspective view of an exemplary assembly comprising an array of pins held by a frame.

FIG. 3 is a perspective cutaway view of the assembly of FIG. 2 showing a releasable fastening mechanism and the array of pins held by the frame.

FIGS. 4-7 illustrate an exemplary flow of sequential steps showing how pins having misaligned liquid dispensing tips can be calibrated.

FIGS. 8-11 illustrate another exemplary flow of sequential steps showing how pins having misaligned liquid dispensing tips can be calibrated.

FIG. 12 shows an exemplary system comprising an array of pins.

FIG. 13 shows exemplary source wells of an exemplary system comprising an array of pins.

FIG. 14 shows exemplary target wells of an exemplary system comprising an array of pins.

FIG. 15 is an exemplary process flow for transferring liquid from source wells to target wells.

FIG. 16 is a side view of an exemplary assembly comprising an array of pins having varied offsets with respect to the frame.

### DETAILED DESCRIPTION

The term “exemplary” as used herein means “serving as an example, illustration or instance”. Any embodiment characterized herein as “exemplary” is not necessarily to be construed as preferred or advantageous over other embodiments.

The term “well” refers to any container or reservoir capable of holding a liquid, including without limitation a well in a multi-well plate, a tube (e.g., a test tube), a vial, and a chamber.

Whenever the term “about” or “approximately” precedes the first numerical value in a series of two or more numerical values or in a series of two or more ranges of numerical values, the term “about” or “approximately” applies to each one of the numerical values in that series of numerical values or in that series of ranges of numerical values. In certain embodiments, the term “about” or “approximately” means within 10% or 5% of the specified value.

In some embodiments of the present invention, pins are held in a frame. The frame contains guide holes or collars by which the pins can slide along the pin axis. The pins have a neck comprising a holding unit (e.g., a nut) that is wider than the holes and also comprising a weight. In certain embodiments, the weight is comprised in the holding unit. By the action of, e.g., gravity or a spring mechanism, the holding unit can rest on a surface of the collar, e.g., on the top surface of the collar. This defines a lowest possible position (e.g., vertical position) for the pins with respect to the frame. When positioned over a reference surface, the distance from the pin tips to the reference surface (measured, e.g., along the axis of the pins) can depend on the disposition of the surface. For example, if the reference surface is parallel with the resting surface of the collar and if the pins have equal length, the pin tips can all be the same distance from the reference surface. In contrast, if the reference surface is uneven with respect to the resting surface, then two or more pin tips, or each pin tip, may have a different distance from the reference surface.

When the frame is moved (e.g., downward) toward a reference surface (such as a plate of wells) or a reference surface is moved toward the frame, the pins can come into contact with the reference surface. As each pin touches the reference surface, at least some of, or most or all of, the weight of the pin becomes borne by the pin tip on the reference surface, rather than by the holding unit on the collar resting surface. As the distance between the frame and the reference surface decreases, the pins, which are slidably contained by the collars, can float or rise with respect to the frame, so that the holding unit of each pin moves away from and no longer sits upon the collar surface. If the line or plane of the reference surface which the pins touch is not parallel with the line or plane of the collar surface on which the weights rest, the pin tips can still conform to the reference surface as a result of the ability of each pin to float independently. If the line or plane of the reference surface is not parallel with the line or plane of the collar surface, the pin tips (or any corresponding point on the shaft of the pin) may not align with each other. In such a case, the invention provides for locking of the pins in position, e.g., by filling a bladder, so that subsequent movement of the frame with respect to the reference surface does not result in sliding of the pins toward the surface of the collar, even if the weight is not resting on the collar. In this locked configuration, when the frame is moved with respect to the reference surface, each pin tip maintains a common distance from its point of contact with the reference surface, regardless of the position of the frame. In contrast, in a frame in which the pins are always locked, the relative distance between each pin tip and the reference surface may not be common if the reference surface is not aligned with the frame. Because the reference surface and the frame in a robot typically are built as an assembly, tight tolerances of the relative position between the frame and the reference surface need to be maintained if the pins are always in a locked position relative to the frame.

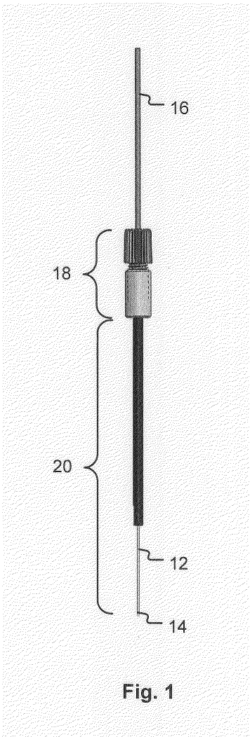

FIG. 1 is a side view of an embodiment of a pin. The pin has a hollow bore 12 and a tip 14. The pin is in fluidic communication with a tube 16. When the tube 16 transmits positive pressure to the hollow bore 12, fluid moves through the hollow bore 12 and is dispensed from the tip 14. When the tube 16 transmits negative pressure to the hollow bore 12, fluid moves into the tip 14 and through the hollow bore 12.

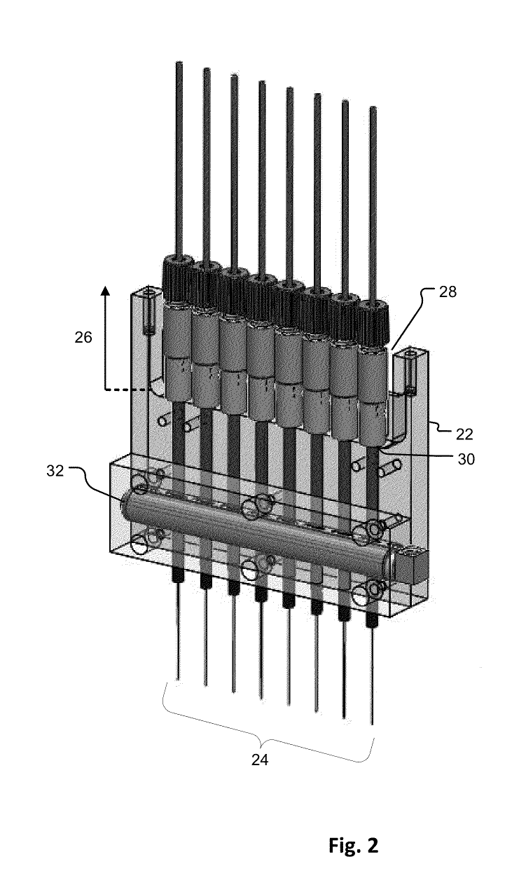

The exemplary pin includes a wider diameter part 18 in communication with the tube 16 and a narrower diameter part 20 in communication with the tip 14. A frame (shown in FIG. 2) which holds the pin has an opening that allows the narrower diameter part 20 to move through the opening, but blocks the wider diameter part 18.

FIG. 2 is a perspective view of an embodiment of an assembly comprising an array of pins held by a frame. The frame 22 holds an array (e.g., a linear array) of pins 24. In certain embodiments, the frame holds a linear array of pins, a two dimensional array of pins, a single pin, or another arrangement.

The frame 22 has a U-shaped cavity 28 occupied by the wider diameter part 18 of the pins. Pins in the array 24 are movably held such that the wider diameter part 18 of the pins can move freely up and down in the U-shaped cavity 28. Because the wider diameter part 18 of each pin is attached to the narrower diameter part 20 of each pin, movement of the wider diameter part 18 of the pins in the U-shaped cavity 28 relative to the frame 22 results in movement of the position (e.g., vertical position) of the narrower diameter part 20 of the pins relative to the frame 22.

The bottom of the U-shaped cavity 28 has openings that allow the narrower diameter part 20 of the pins to move through the openings, but block the wider diameter part 18 from moving through the openings. Each of the pins in the array 24 has a corresponding opening in the bottom of the U-shaped cavity 28. One such opening is opening 30 for the rightmost pin shown in FIG. 2. The U-shaped cavity 28 also has a top (not shown in FIG. 2) which blocks further upward movement of the wider diameter part 18. The top and bottom of the U-shaped cavity 28 limit the range of movement of the positions (e.g., vertical positions) of the pins in the array 24 relative to the frame 22.

In the embodiment of FIG. 2, the fastening mechanism 32 comprises a variable volume bladder. When the fastening mechanism 32 is deflated, the fastening mechanism 32 allows the pins in the array 24 to change their positions (e.g., vertical positions) relative to the frame 22. When the fastening mechanism 32 is inflated, the fastening mechanism 32 fixes the pins in the array 24 to their positions (e.g., vertical positions) relative to the frame 22.

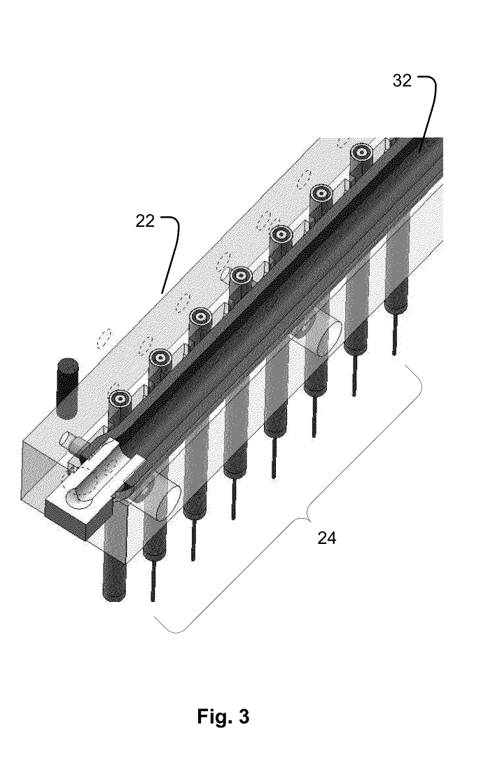

FIG. 3 is a perspective cutaway view of the releasable fastening mechanism and the array of pins held by the frame of the assembly in FIG. 2. The pins in the array 24 have positions (e.g., vertical positions) relative to the frame 22, fixed by the fastening mechanism 32. The cutaway view shows a cross-section of the fastening mechanism 32. In the embodiment shown in FIG. 3, the releasable fastening mechanism comprises a variable volume bladder. In other embodiments, the releasable fastening mechanism comprises a magnetic fastener or fastening mechanism, or a mechanical fastener or fastening mechanism.

The shown portion of the frame 22 has multiple notches. In some embodiments, the pins are positioned in the indented parts of the notches. When the fastening mechanism 32 inflates, the fastening mechanism 32 applies pressure to the pins, pressing the pins against the indented parts of the notches. By being pressed against the indented parts of the notches, the pins are fastened in their positions (e.g., vertical positions) relative to the frame 22. When the fastening mechanism 32 deflates, the fastening mechanism 32 no longer applies pressure to the pins, and the pins are no longer fastened in their positions (e.g., vertical positions) relative to the frame 22.

In other embodiments, the releasable fastening mechanism comprises a mechanical fastening mechanism. In some embodiments, the mechanical fastening mechanism comprises a clamp and springs. In certain embodiments, the clamp comprises a non-compliant piece and a compliant piece composed of a compliant material (e.g., an elastomeric material, such as a foam or rubber material). The springs can be loaded or unloaded to apply pressure to the clamp and thus the pins, or to release pressure from the clamp and thus the pins, using any suitable mechanism or device, such as a source of electromagnetic force (e.g., a solenoid) or a source of pneumatic force (e.g., a pneumatic actuator). Use of a compliant material can allow the clamp to better fasten pins of non-uniform dimensions (e.g., non-uniform diameters) to the frame.

In yet other embodiments, the releasable fastening mechanism comprises a magnetic fastening mechanism. In some embodiments, the magnetic fastening mechanism comprises a clamp, guide pieces, and magnets. The clamp slides along guide pieces toward and away from magnets attached to the frame. In certain embodiments, the clamp comprises a non-compliant piece and a compliant piece composed of a compliant material (e.g., an elastomeric material, such as a foam or rubber material). The clamp can be closed to apply pressure to the pins, and the clamp can be opened to release pressure from the pins, using any suitable mechanism or device, such as a source of electromagnetic force (e.g., a solenoid) or a source of pneumatic force (e.g., a pneumatic actuator). Use of a compliant material can allow the clamp to better fasten pins of non-uniform dimensions (e.g., non-uniform diameters) to the frame.

The disclosed technology can dispense larger liquid samples into larger-volume (e.g., macrofluidic) wells and smaller liquid samples into smaller-volume microwells or microfluidic wells.

The present invention provides advantages for dispensing smaller amounts of liquid sample. As the amounts of sample dispensed from a pin into a well become smaller, the relative position of the tip of the pin and the well may become more important. With sufficiently small sample amounts (e.g., less than about 10, 5, 1 or 0.5 microliter), gravity alone may be insufficient to cause the sample to be dispensed from the pin tip. Adhesion between very small sample volumes and the dispensing tip of the pin may overcome gravity, preventing the sample from being dispensed into the well.

With very small sample amounts, the dispensing tip of the pin can be positioned close to the bottom surface of the well. As the sample is dispensed from the dispensing tip of the pin, the sample physically touches the bottom surface of the well. Adhesion between the dispensed sample and the bottom surface of the well can overcome adhesion between the dispensed sample and the dispensing tip of the pin.

When dispensing very small sample amounts, accurate positioning of the dispensing pin tip relative to the well can permit the sample to be dispensed into the well. If the dispensing tip of the pin is not positioned sufficiently close to the bottom of the well, then the sample being dispensed may fail to physically touch the bottom of the well, and the sample may not be dispensed into the well. On the other hand, if the dispensing tip of the pin is positioned too close to the bottom of the well, then there may be insufficient space between the sample being dispensed and the bottom of the well. Furthermore, if the dispensing tip of the pin is immovably fixed to a frame, and the dispensing tip of the pin is moved too far into the well, then the pin or the well, or both, may be damaged.

A traditional approach to dispensing small amounts of liquid sample is to manufacture the overall system to a tight physical tolerance. However, the required tolerance for pins that dispense small samples may be on the order of 0.5 mm or less. Such a tight tolerance may be difficult and time-consuming to achieve. Because the position of every pin requires calibration to a specified tolerance, the tolerance problem may worsen as the number of pins in an array increases.

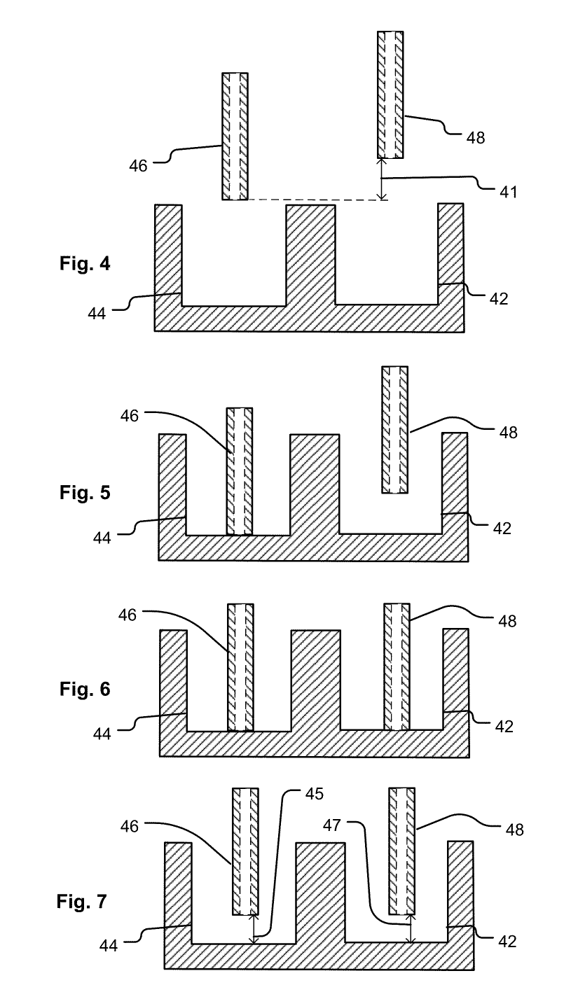

FIGS. 4-7 illustrate an exemplary flow of sequential steps showing how pins with misaligned liquid dispensing tips can be calibrated. Multiple pins in an array are uncalibrated or otherwise miscalibrated, such that the ends of the liquid dispensing tips are not in the same z-plane, or not at the same height. In other embodiments, there can be many more pins in a linear array along a substantially straight line, and/or in a 2-D array. The pins can be held by a frame, such as shown in FIGS. 2 and 3.

FIGS. 4-7 show the ends of the liquid dispensing tips of two hollow bore pins 46 and 48, and two target wells 42 and 44. The frame holding the pins 46 and 48 is not shown. The pins 46 and 48 are miscalibrated or misaligned, as shown by the gap 41 in the z-axis or height between the tips of the pins 46 and 48.

FIG. 4 shows the ends of the pins 46 and 48 prior to being moved into the target wells 44 and 42. The bottom surfaces of wells 42 and 44 are at the same depth, or the same position in the z-axis. The releasable fastening mechanism has not fastened the pins 46 and 48 to their positions relative to the frame.

FIG. 5 shows the pins 46 and 48 being moved into the wells such that the end of the pin 46 makes contact with the bottom surface of well 44. However, the end of the pin 48 has not made contact with the bottom surface of well 42. The releasable fastening mechanism still has not fastened the pins 46 and 48 to their positions relative to the frame.

FIG. 6 shows that the frame holding the pins 46 and 48 continues to move toward the wells. The releasable fastening mechanism still has not fastened the pins 46 and 48 to their positions relative to the frame. Contact between the end of pin 46 with the bottom surface of well 44 pushes up pin 46 relative to the frame. The motion of the frame towards the wells continues at least until pin 48 makes contact with the bottom surface of well 42. When the end of pin 48 contacts the bottom of well 42, the frame may continue to move, or may overdrive, such that contact between the end of pin 48 with the bottom surface of well 42 may push up pin 48 relative to the frame. The motion of the frame continues at least until the ends of all pins in the array which are undergoing calibration contact the bottom of their respective well, which may push up the pins relative to the frame. At this point, the releasable fastening mechanism may fasten the pins 46 and 48, or all pins in the array, to their positions relative to the frame.

FIG. 7 shows the ends of the pins 46 and 48 moved away from the bottom surfaces of the target wells 44 and 42. The pins 46 and 48 are calibrated, and the distances 45 and 47 are equal, respectively, between the end of pin 46 and the bottom surface of well 44, and between the end of pin 48 and the bottom surface of well 42.

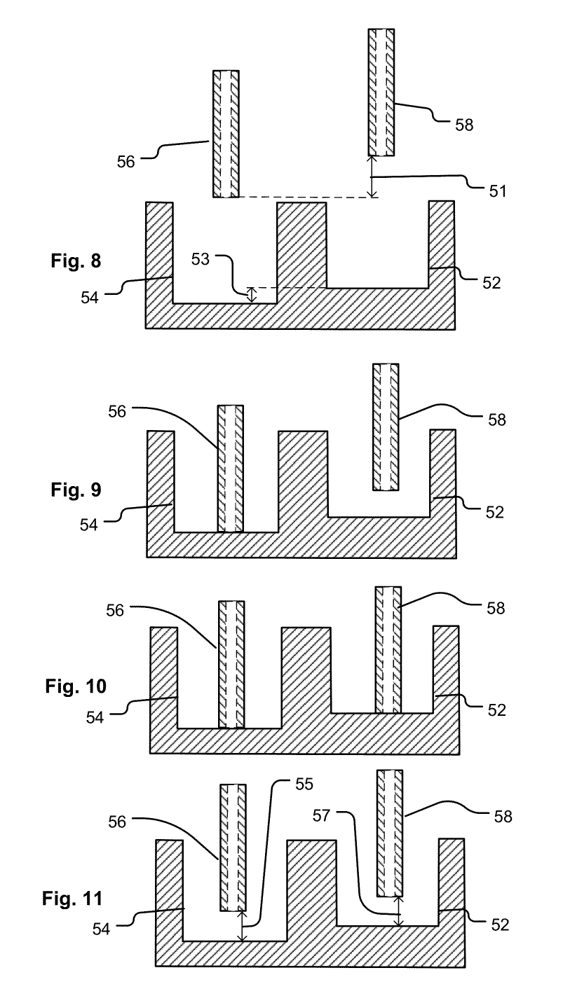

FIGS. 8-11 illustrate another exemplary flow of sequential steps showing how hollow bore pins with misaligned liquid dispensing tips can be calibrated. The frame holding the pins 56 and 58 is not shown. The flow shown in FIGS. 8-11 is broadly similar to the flow shown in FIGS. 4-7. The pins 56 and 58 are miscalibrated or misaligned, as shown by the gap 51 in the z-axis or height between the ends of the pins 56 and 58. In FIGS. 8-11, the bottom surfaces of wells 52 and 54 are at different depths, or different positions in the z-axis, with a depth difference 53. The pins 56 and 58 have not been calibrated for the wells 54 and 52, and the gap 51 is different than the depth difference 53.

FIG. 8 shows the ends of the pins 56 and 58 prior to being moved into the target wells 54 and 52. The bottom surfaces of wells 52 and 54 are at different depths, or different positions in the z-axis, with a depth difference 53. The releasable fastening mechanism has not fastened the pins 56 and 58 to their positions relative to the frame.

FIG. 9 shows the pins 56 and 58 being moved into the wells such that the pin 56 makes contact with the bottom surface of well 54. However, the pin 58 has not made contact with the bottom surface of well 52. The releasable fastening mechanism still has not fastened the pins 56 and 58 to their positions relative to the frame.

FIG. 10 shows that the frame holding the pins 56 and 58 continues to move toward the wells. The releasable fastening mechanism still has not fastened the pins 56 and 58 to their positions relative to the frame. Contact between the end of pin 56 with the bottom surface of well 54 pushes up pin 56 relative to the frame. The motion of the frame towards the wells continues at least until pin 58 makes contact with the bottom surface of well 52. When the end of pin 58 contacts the bottom of well 52, the frame may continue to move, or may overdrive, such that contact between the end of pin 58 with the bottom surface of well 52 may push up pin 58 relative to the frame. The motion of the frame continues at least until the ends of all pins in the array which are undergoing calibration contact the bottom of their respective well, which may push up the pins relative to the frame. At this point, the releasable fastening mechanism may fasten the pins 56 and 58, or all pins in the array, to their positions relative to the frame.

FIG. 11 shows the ends of the pins 56 and 58 moved away from the bottom surfaces of the target wells 54 and 52. The pins 56 and 58 are calibrated, and the distances 55 and 57 are equal, respectively, between the end of pin 56 and the bottom surface of well 54, and between the end of pin 58 and the bottom surface of well 52.

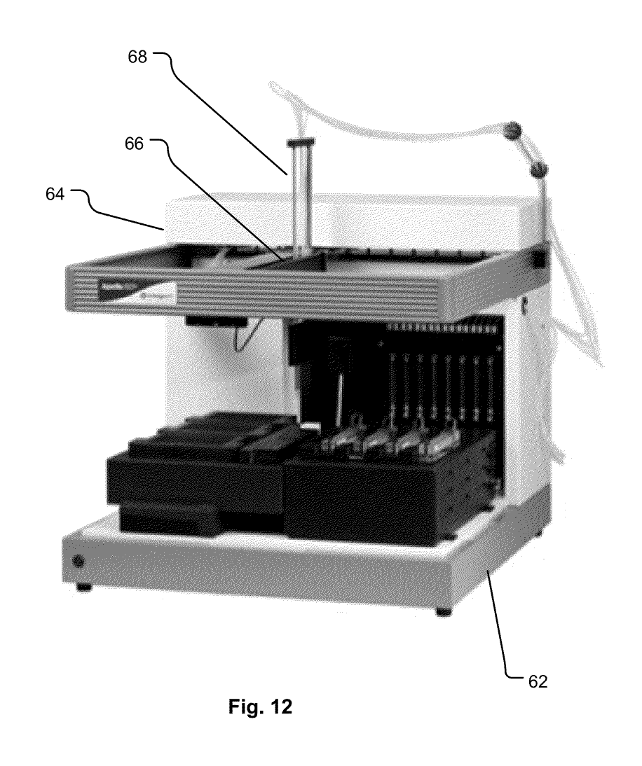

FIG. 12 shows an exemplary system comprising an array of pins and a base 62. The base 62 supports a housing 64 and a frame 66 which holds the pins 68. The plane of the base 62 defines a horizontal plane, or x-y plane. The housing 64 contains the motor which moves the frame 66 along the z-axis, or up and down, and around the x-y plane, or right, left, forwards and backwards. The housing 64 also contains the control circuit which causes the motor to move the frame 66 and the pins 68.

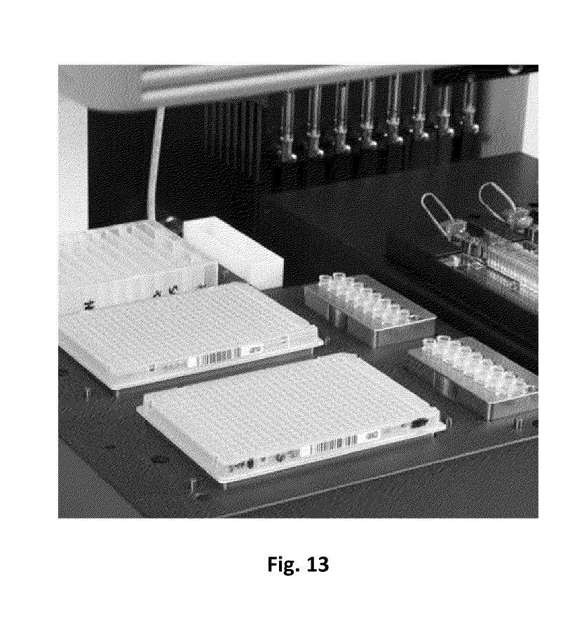

FIG. 13 shows exemplary source wells of an exemplary system comprising an array of pins.

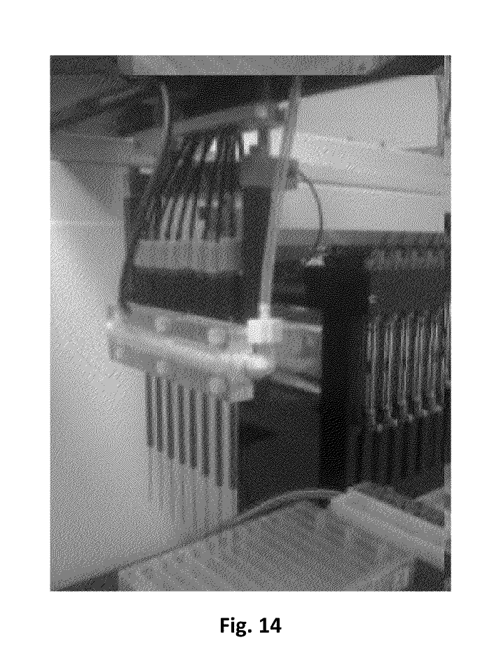

FIG. 14 shows exemplary target wells of an exemplary system comprising an array of pins. A linear array of pins is above the target wells. The target wells can be part of, e.g., a macrofluidic or microfluidic device.

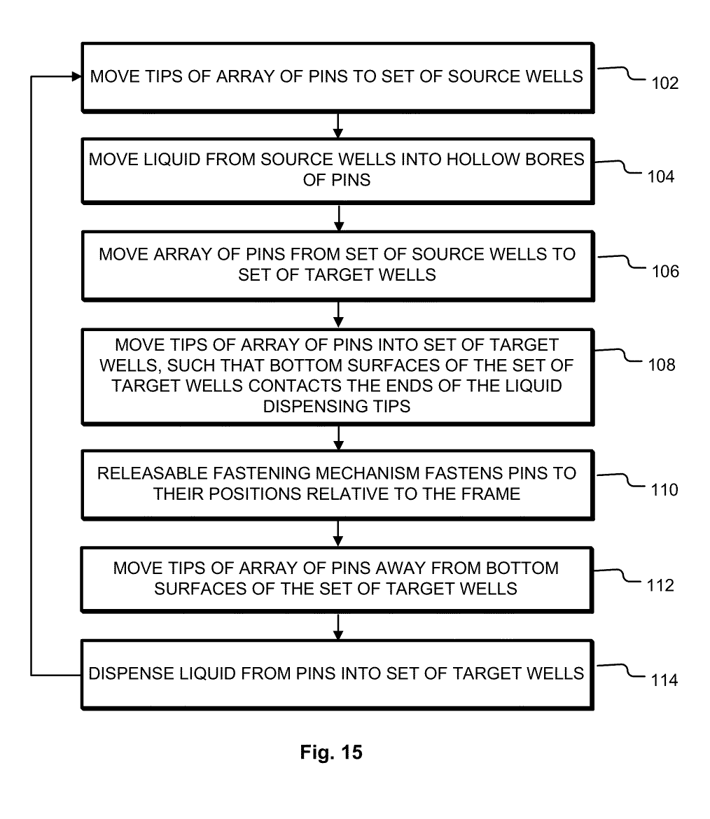

FIG. 15 is an exemplary process flow of the control circuit causing the motor to move the frame holding the pins, and causing the releasable fastening mechanism to fasten and unfasten the pins to and from their particular positions (e.g., vertical positions) relative to the frame. In other embodiments, steps can be added to the exemplary process flow, or steps of the exemplary process flow can be deleted, modified or rearranged.

In step 102, the array of pins moves in the x-y plane to a set of source wells, and the tips of the array of pins are moved into the set of source wells by moving the frame holding the pins along the z-axis to lower the height of the pins. In step 104, liquid is moved from the source wells into the array of pins. This can be accomplished by applying negative pressure to tubes connected to the array of pins. The tips of the array of pins are moved out of the set of source wells by moving the frame holding the pins along the z-axis to raise the height of the pins. In step 106, the array of pins is moved in the x-y plane from the source wells to a set of target wells.

In the embodiment of FIG. 15, the array of pins is calibrated as follows. In step 108, the tips of the array of pins are moved into the set of target wells. The frame holding the pins moves toward the target wells, such that the bottom surfaces of the target wells make contact with the liquid dispensing tips of the array of pins. At this time, the releasable fastening mechanism may not have fastened the pins to the frame, so the contact between the liquid dispensing tips and the bottom surfaces of the target wells may push up the positions of the pins relative to the frame. The frame may be overdriven in the z-axis, such that the frame may continue to move toward the target wells after all of the liquid dispensing tips of the pins have contacted the bottom surfaces of their respective target wells. In step 110, the releasable fastening mechanism fastens the pins to their positions (e.g., vertical positions) relative to the frame. Calibration of the array of pins is complete.

In step 112, the tips of the array of pins are moved away from the bottom surfaces of the set of target wells by moving the frame holding the pins along the z-axis to raise the height of the pins. This allows space for liquid to exit the liquid dispensing tips. In step 114, liquid is dispensed from the pins into the set of target wells. This can be accomplished by applying positive pressure to the tubes connected to the array of pins.

This process may be repeated as needed to move additional liquid samples from source wells into target wells.

In other embodiments, the calibration of the pins can precede or follow the movement of liquid from the source wells into the pins. In another embodiment, pin calibration is performed with a single pin. In some embodiments, the array of pins is a linear array of pins or a two-dimensional array of pins. In further embodiments, pin calibration is performed for the source wells in addition to the target wells, or for the source wells instead of the target wells.

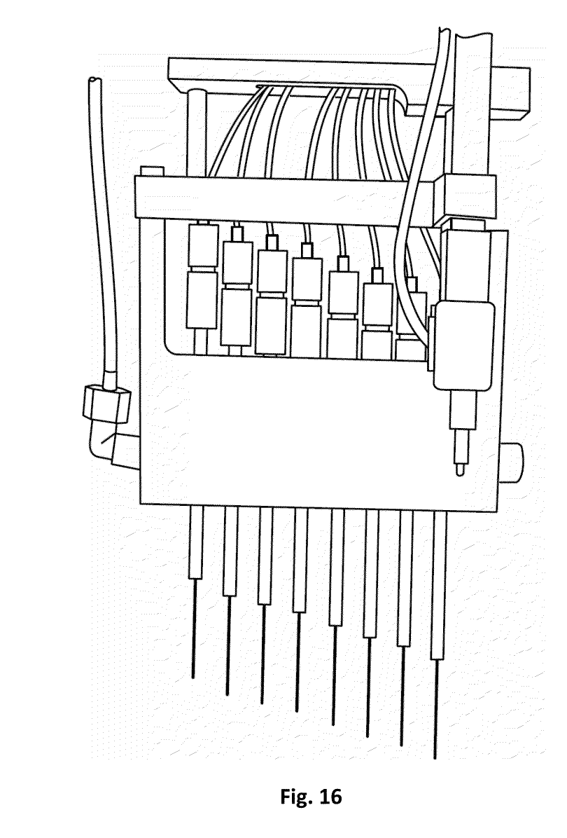

FIG. 16 is a side view of an exemplary assembly comprising an array of pins that have varied degrees of floating, or offsets with respect to the frame.

The left-most pin is offset relative to the frame to have the highest vertical position among the array of pins. The right-most pin is offset relative to the frame to have the lowest vertical position among the array of pins. The intermediate pins have offsets relative to the frame in between the offsets of the left-most pin and the right-most pin. In one embodiment, as the assembly is lowered, the tip of the right-most pin is the first pin tip to make contact with a bottom surface of a well, the tip of the left-most pin is the last pin tip to make contact with a bottom surface of a well, and the tips of the intermediate pins make contact with respective wells at intermediate time points. The offset arrangement in FIG. 16 is illustrative, and in other embodiments the offsets are by different amounts vertically and/or the pins are offset vertically in different orders.

While the present invention is disclosed by reference to embodiments and examples described above, it is to be understood that these embodiments and examples are intended to be illustrative rather than limiting. It is contemplated that modifications and combinations of embodiments and examples described herein will readily occur to those skilled in the art, which modifications and combinations will be within the spirit of the invention and the scope of the following claims.

1. A method comprising:
moving a frame movably holding at least one hollow bore pin having a liquid dispensing tip, such that the liquid dispensing tip of the at least one hollow bore pin moves into a respective well of a set of target wells, and the liquid dispensing tip makes contact with a bottom surface of the respective well;
continuing to move the frame after the liquid dispensing tip makes contact, such that the at least one hollow bore pin moves to a particular position within a range of positions relative to and permitted by the frame; and
fastening the at least one hollow bore pin to the frame at the particular position of the at least one hollow bore pin relative to the frame.

2. The method of claim 1, wherein the at least one hollow bore pin is a plurality of hollow bore pins, and wherein the method further comprises:
(1) moving the frame toward the set of target wells until each of the plurality of hollow bore pins contacts the bottom surface of a respective well of the set of target wells, wherein each of the plurality of hollow bore pins assumes a position relative to the frame;
(2) fastening the plurality of hollow bore pins to the frame at the relative positions; and
(3) moving the plurality of hollow bore pins away from the bottom surfaces of the set of target wells.

3. The method of claim 2, further comprising:
moving liquid into the plurality of hollow bore pins from a set of source wells; and
moving the frame from the set of source wells to the set of target wells.

4. The method of claim 1, further comprising:
after fastening, moving the frame from the set of target wells to a set of source wells;
moving liquid into the at least one hollow bore pin from the set of source wells; and
moving the frame from the set of source wells to the set of target wells.

5. The method of claim 1, wherein the at least one hollow bore pin includes a plurality of hollow bore pins, and wherein said continuing to move the frame after the liquid dispensing tip makes contact comprises continuing to move the frame at least until the plurality of hollow bore pins stop moving relative to each other.

6. The method of claim 1, further comprising:
moving the liquid dispensing tip of the at least one fastened hollow bore pin to a target distance from the bottom surface of the respective well; and
dispensing a quantity of liquid from the liquid dispensing tip into the respective well.

7. The method of claim 1, further comprising:
moving the liquid dispensing tip of the at least one fastened hollow bore pin to a target distance from the bottom surface of the respective well; and
dispensing a quantity of liquid of no more than about 0.5 microliter from the liquid dispensing tip into the respective well.

8. The method of claim 1, further comprising:
moving the liquid dispensing tip of the at least one fastened hollow bore pin to a target distance from the bottom surface of the respective well, such that a quantity of liquid dispensed from the liquid dispensing tip contacts both the liquid dispensing tip and the bottom surface of the respective well.

9. The method of claim 1, wherein the wells are part of a microfluidic device.

10. The method of claim 2, wherein the liquid dispensing tips of the plurality of hollow bore pins can have the same vertical position or different vertical positions with respect to each other.

11. The method of claim 1, wherein the bottom surfaces of the set of target wells can have the same vertical position or different vertical positions with respect to each other.

12. The method of claim 2, wherein
the liquid dispensing tips of the plurality of hollow bore pins are permitted to have misalignment in a vertical position relative to each other such that at least two of the liquid dispensing tips have vertical positions differing by more than about 0.5 mm.

13. The method of claim 1, wherein
the wells of the set of target wells are permitted to have misalignment in a vertical position relative to each other such that the bottom surfaces of at least two of the wells have vertical positions differing by more than about 0.5 mm.

14. An apparatus comprising:
at least one hollow bore pin having a liquid dispensing tip;
a frame movably holding the at least one hollow bore pin within a range of positions relative to the frame; and
a releasable fastening mechanism coupled to the frame and having a first mode in which the at least one hollow bore pin is movable within the range of positions relative to the frame and a second mode in which the at least one hollow bore pin is fixed at a particular position in the range of positions relative to the frame.

15. The apparatus of claim 14, wherein the range of positions lies along a line.

16. The apparatus of claim 14, wherein the at least one hollow bore pin is a plurality of hollow bore pins, and wherein each pin of the plurality of hollow bore pins is fixable at a particular position relative to the frame independent of the other pins of the plurality of hollow bore pins.

17. The apparatus of claim 14, wherein the releasable fastening mechanism comprises a variable volume bladder.

18. The apparatus of claim 14, wherein the releasable fastening mechanism comprises a magnetic fastener or fastening mechanism.

19. The apparatus of claim 14, wherein the releasable fastening mechanism comprises a mechanical fastener or fastening mechanism.

20. The apparatus of claim 16, further comprising a plurality of tubes, wherein each of the plurality of tubes is in fluidic communication with a respective pin of the plurality of hollow bore pins and is adapted to transmit positive or negative pressure to the respective pin.

21. An apparatus comprising:
a base;
a frame and pin assembly coupled to the base and comprising a frame movably holding an array of hollow bore pins, wherein each of the hollow bore pins has a liquid dispensing tip and is within a range of positions relative to and permitted by the frame; and
a releasable fastening mechanism coupled to the frame and having a first mode in which each of the hollow bore pins is movable within the range of positions relative to the frame and a second mode in which each of the hollow bore pins is fixed at a particular position in the range of positions relative to the frame; and
a motor configured to move the frame in X, Y, and Z directions relative to the base.

22. The apparatus of claim 21, wherein the X and Y directions are relative to an X and Y plane defined by the base, and the Z direction is perpendicular to the X and Y plane.

23. The apparatus of claim 21, further comprising an array of wells.

24. The apparatus of claim 21, wherein the releasable fastening mechanism comprises a variable volume bladder.

25. The apparatus of claim 21, wherein the releasable fastening mechanism comprises a magnetic fastener or fastening mechanism.

26. The apparatus of claim 21, wherein the releasable fastening mechanism comprises a mechanical fastener or fastening mechanism.

27. The apparatus of claim 21, further comprising:
a control circuit coupled to the motor and the releasable fastening mechanism, wherein the control circuit is configured:
(i) to cause the motor to move the liquid dispensing tips of the array of hollow bore pins into an array of wells such that the liquid dispensing tips make contact with bottom surfaces of the array of wells, and such that the contact moves the array of hollow bore pins to particular positions within the range of positions relative to and permitted by the frame holding the array of hollow bore pins; and
(ii) to cause the releasable fastening mechanism to fasten the array of hollow bore pins to the particular positions relative to the frame and determined by the contact between the liquid dispensing tips and the bottom surfaces of the array of wells.

28. The apparatus of claim 21, wherein each of the hollow bore pins is fluidically connected to a respective tube of a plurality of tubes.
